(19) United States
(12) Patent Application Publication
(10) Pub. No.: US 2014/0289603 A1
(43) Pub. Date: Sep. 25, 2014

(54) ANNOTATING AND LINKING MEDIA CONTENT DATA

(71) Applicants: Sudhee Nagabhushan Subrahmanya, Austin, TX (US); Kaushik Nagabhushan, Plano, TX (US)

(72) Inventors: Sudhee Nagabhushan Subrahmanya, Austin, TX (US); Kaushik Nagabhushan, Plano, TX (US)

(21) Appl. No.: 14/245,507

(22) Filed: Apr. 4, 2014

Related U.S. Application Data
(60) Provisional application No. 61/760,568, filed on Feb. 4, 2013.

(51) Int. Cl. G06F 17/24

(52) U.S. Cl. CPC G06F 17/241
USPC 715/230

(57) ABSTRACT

A method of linking multiple media data using a time line for context and replay is disclosed. The method allows for various kinds of media to be linked and may use a time line to facilitate such linking, either from an existing media file, such as a video clip, or by creating a new file. The time line may be leveraged to start, open, display, or seek to specific points in other unstructured data. The original artifacts of the file are not changed, but the user may be provided the opportunity to view multiple artifacts (like video or an e-book, along with annotations added in by a teacher or friend) together and gain a comprehensive contextual understanding.

### CLAIM OF BENEFIT TO PRIOR APPLICATION

This application claims benefit to United States Provisional Patent Application 61/760,568, entitled “A Method Of Linking Multiple Media Data Using A Time Line For Context And Replay,” filed Feb. 4, 2013. The United States Provisional Patent Application 61/760,568 is incorporated herein by reference.

### BACKGROUND

The rapid growth of media such as video, audio, e-books, text, and other types of electronic or digital media is changing the way people use social networks and the Internet. One issue with the proliferation of these various media types and files is the data are not linked to each other and users accessing these data may not have access to any contextual information to have a comprehensive experience.

Conventional approaches to the viewing of these files and data are carried out by systems where the various media are accessed and viewed as standalone entities. The user involved may read or view the various pieces of media and is able to understand the information but there is no comprehensive presentation of all related information that might useful in understanding or interpreting the data. There is no way for pieces of annotations to be tied to other unstructured data, shared and/or played in a social manner with additions from multiple users.

Improvements to the approach to providing linking or annotation information to a user accessing media files are desirable.

### BRIEF DESCRIPTION

Some embodiments of the invention include a system and a method that allow various kinds of media to be linked. In some embodiments, the system includes a time line that is incorporated based on a media content data item. The media content data item is one of an existing media content data item and a newly created media content data item. The media content data item is a video content clip in some embodiments. In some embodiments the time line facilitates access to structured and unstructured data in the media content data item. Specifically, the time line facilitates access access to the media content data item by providing a set of access operations to the media content data item. In some embodiments, the set of access operations comprise a start operation, an open operation, a display operation, and a seek operation, with each operation facilitating access to the media content data item.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates schematic view of media content data annotating and linking system in some embodiments.

FIG. 2 conceptually illustrates a method for using a time line to annotate and link multiple media content data items in some embodiments.

FIG. 3 conceptually illustrates a schematic view of a master time line with relative video time lines in some embodiments.

FIG. 4 conceptually illustrates a schematic view of a time stamp table used in relation to actions set by one or more users of a media content data annotating and linking system in some embodiments.

FIG. 5 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for use in several different circumstances.

A system and a method in some embodiments allow for various kinds of media to be linked. In some embodiments, the system includes a time line that is incorporated based on a media content data item. The media content data item is one of an existing media content data item and a newly created media content data item. The media content data item is a video content clip in some embodiments. In some embodiments the time line facilitates access to structured and unstructured data in the media content data item. Specifically, the time line facilitates access access to the media content data item by providing a set of access operations to the media content data item. In some embodiments, the set of access operations comprise a start operation, an open operation, a display operation, and a seek operation, with each operation facilitating access to the media content data item.

In some embodiments, the original data or information artifacts of a file are left unchanged even when the time line is used to link various artifacts together and while the user is provided the opportunity to view multiple artifacts (like video, and an e-book, along with annotations added in by a third party, such as a teacher or friend) together and gain a comprehensive contextual understanding.

In some embodiments, the system and method provide ways for resources of multiple types, such as videos, text, photographs, web links etc., to be collected and linked together using a time line or time stamp. The resources could be related to a common event or subject. Once linked, this collection of resources can be shared as a whole with others. For instance, the collection of linked resources may be shared with a set of students, a group of club members, multiple family members, friends, etc. In some embodiments, the system and method further allow users to add links or text. In this way, the collection of resources and any additional links or text items are all captured at locations along the time line or at specific time-points.

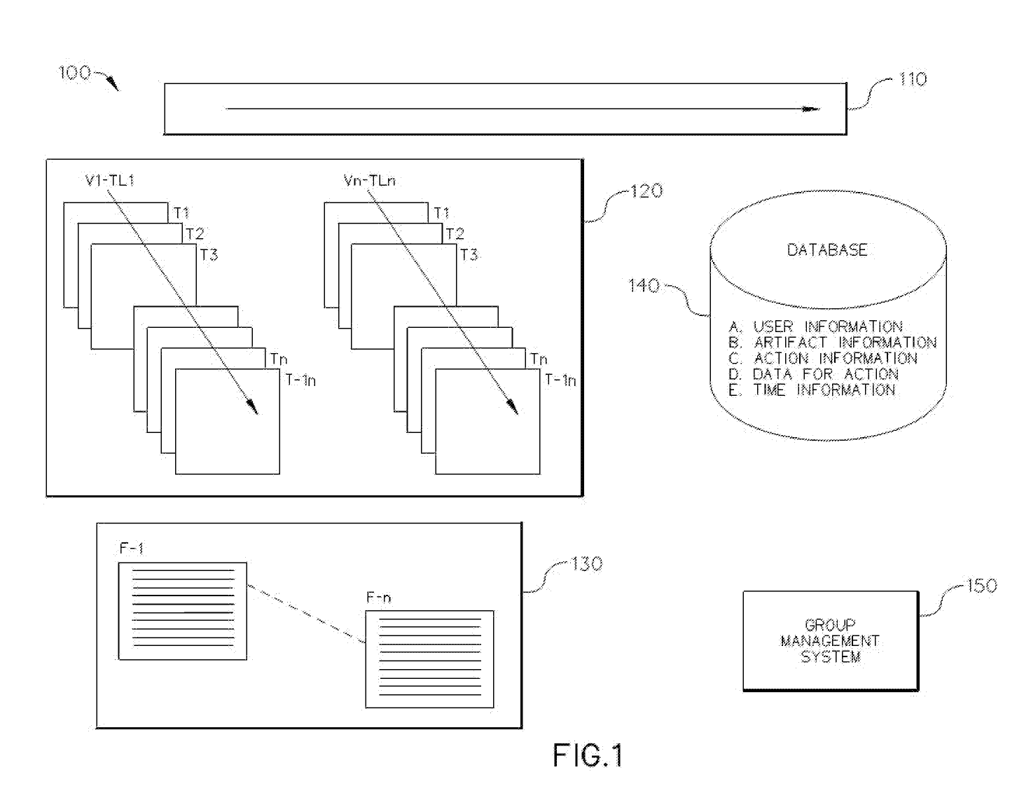

By way of example, FIG. 1 conceptually illustrates schematic view of media content data annotating and linking system 100 in some embodiments. As shown in this figure, the media content data annotating and linking system includes a master time line 110, a set of artifacts with time lines 120, a set of artifacts without time lines 130, a database 140, and a group management system 150. The master time line 110 is a time line created to be a common simulated time line for any media or file type. The set of artifacts with time lines 120 are those resources that have embedded or existing time lines that are associated with timing flow of related media content stored in the file format for playback (e.g., video clips, animations, audio content, etc.). The set of artifacts without time lines 130 include other resources that may be linked, using the master time line 110, to one or more of the resources in the collection, but which do not include an existing or embedded time line relative to the type of content of the file (e.g., files without time lines, such as PDF, images, web sites, social media sites, etc.). The database 140 includes stored and retrievable data associated with (a) user information (e.g., user accounts, permissions, etc.), (b) the artifact on which an action is to be performed, (c) the action to be taken with regard to that artifact, (d) data needed for executing the action, and (e) the time at which the action needs to be executed, etc. The group management system 150 is a user/group management application or module that the media content data annotating and linking system 100 uses for managing users, groups, and sharing permissions. Also, other features, applications, data sources/repositories, and systems may be incorporated into the media content data annotating and linking system 100. Thus, a person skilled in the art relevant to this disclosure would understand that the components included in the example media content data annotating and linking system 100 shown in FIG. 1 are not inclusive of all components that may be included in a media content data annotating and linking system of some embodiments.

In some embodiments, a flow of time is simulated when a time line is created or used. With this simulated flow of time, the various media resources can be started, text-notes can be displayed, e-textbooks, PDF files and other data can also be scrolled to, searched/seeked for, or displayed relative to each other as needed. The time-line that is created can be based off of a video that is in the collection or created independently. The ability to start a video and then display, at specific points along the time line, notes or a section of a textbook or other media allows a user to gain a contextual understanding of the media.

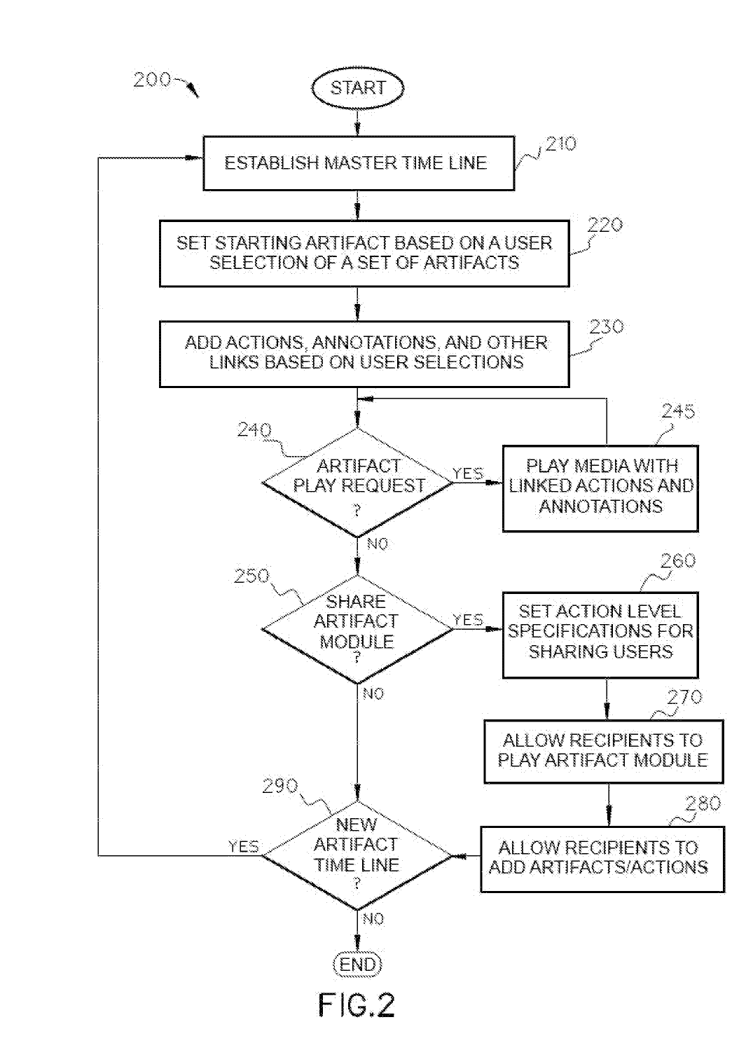

FIG. 2 conceptually illustrates a method 200 for using a time line to annotate and link multiple media content data items in some embodiments. The method 200 of some embodiments is performed by a software application running on a computing device. As shown, the method 200 includes a set of steps at which the method performs operations. Specifically, the method 200 begins by establishing (at 210) a master time line. A user of the software application may access a user interface to make selections of artifacts to use as starting artifacts. When this is done by the user, the method 200 sets (at 220) the starting artifact based on the user's selection of artifacts. The starting artifact is set by the method 200 for a module or collection of artifacts to be worked on. For instance, the user may have selected a video content file or another file as the starting artifact.

Next, the method 200 adds (at 230) artifact links and actions to the starting artifact based on the user's choice of artifacts to add, including actions related to the media, annotations pertaining to the media content, and other links as the user may wish to include for comprehensive understanding of the media. For example, the user may have inserted a note or comment at a specific point of the media file, or may have chosen an action, such as starting video content playback or opening a document for viewing. If the media file associated with the artifact has a native (e.g., existing or embedded) time line, the artifact time will be set relative to the native time line. If no time line is natively associated with the starting artifact, then the linked artifacts or actions will be associated with the master time line that was established (at 210) by the method 200.

At some point when one or more actions or artifacts are set to the time line of the media, the method 200 receives (at 240) an artifact playback command selected by the user. At this point, the method plays/displays/shows (at 245) whatever artifacts and/or actions have been linked. The method may also receive (at 250) a user selection to share a module incorporating the artifacts along with the linked actions. The user may select one or more other users as recipients of the shared module, depending on security permissions and group settings managed by the group management system of some embodiments. The method may also receive (at 260) action level designations which outline rules for further sharing by the initial set of users chosen to have shared access to the module.

Once the module is shared with other users, the method 200 allows (at 270) the recipient users to play the module, with the artifacts and associated annotations and other artifacts as needed, depending on each recipient user's security profile (e.g., security settings, group affiliations, and sharing permissions). In some embodiments, the method allows (at 280) recipient users to add actions and/or artifacts, again depending on each recipient user's security profile, and to share such added actions or artifacts with other users, depending the security profiles of the action/artifact setting user and the user which the action/artifact is being shared with. The method then determines (at 290) whether the user is going to establish a new master time line, in which case the method will revert to the start in order to establish a new time line (at 210). The method 200 continues until the user quits the application or the content is rendered unworkable (i.e., deleted or corrupted).

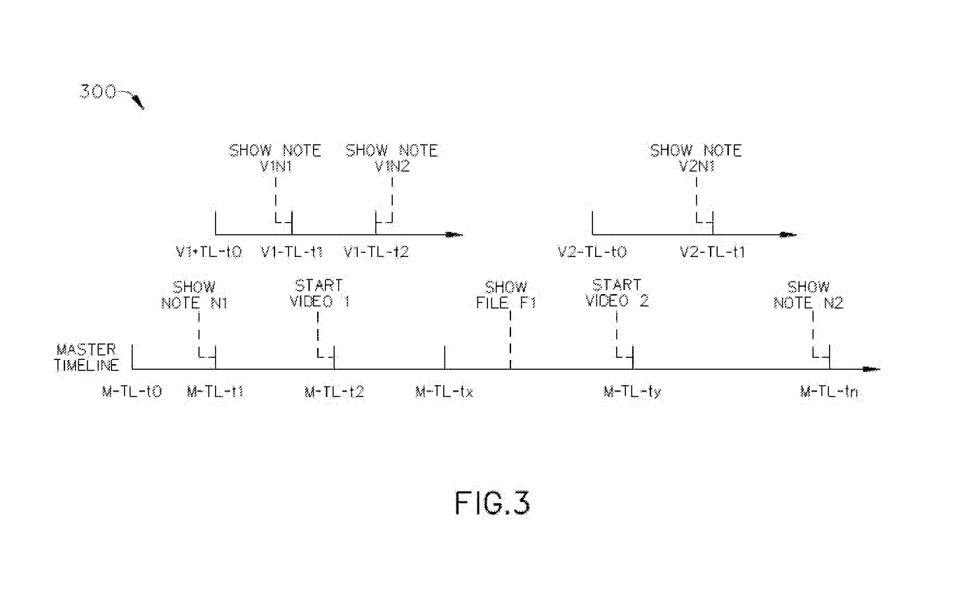

In another of example, FIG. 3 conceptually illustrates a schematic view 300 of a master time line with relative video time lines in some embodiments. As shown in this figure, the master time line (M-TL) runs a simulated time frame starting at time t0 and proceeding to time tn and beyond. Specific points along the master time line M-TL are linked with other resources and artifacts. In particular, there is a link to an annotation-type artifact at time t1 to “Show Note N1”. Then at time t2 there is a link to “Video 1” which can then be started. An existing annotation along master time line M-TL provides for showing “File F1”, sometime after time tx. Later, the master time line M-TL includes a link to “Video 2” so that it can be started at the user-indicated time ty. The master time line M-TL also includes an artifact to “Show Notes N2” at time tn.

As can be seen in FIG. 3, each of the video clips “Video 1” and “Video 2” have relative time lines of their own. In some embodiments, the relative time lines are embedded within the media format of the respective video files. This is different from the master time line M-TL, which is created (or opened from a saved project). Furthermore, each of the time lines V1 for “Video 1” and V2 for “Video 2” include existing artifacts that have been left unchanged by operations performed in relation to the master time line M-TL. Specifically, Video 1 time line V1-TL includes two artifacts for showing “Note V1N1” and “Note V1N2”, at relative times t1 and t2 along the Video 1 time line V1-TL. Similarly, Video 2 time line V2-TL includes existing artifact “Show Note V2N1” at relative time t1, along the Video 2 time line V2-TL. In relation to the master time line M-TL, the relative times along the Video 1 time line V1-TL and Video 2 time line V2-TL are different in real terms because Video 1 is started at an earlier time along the master time line M-TL than the time at which Video 2 is started. In other words, the relative time V1-TL-t1 is associated with a first time along simulated time flow of the master time line M-TL and the relative time V2-TL-t1 is associated with a different second time along simulated time flow of the master time line M-TL.

The system and method of the present disclosure may also allow for the sharing of this media along with its annotated data with other users using a social network or any other network. This usage of a time line for linking together media relative to a time line and then allowing for sharing of this information, along with annotations, solves the problem of providing a context and a user may then able to get a more comprehensive experience. For example, a student may watch a video which is linked to a related e-book that can the student can use to look up and better understand the information presented in the video.

The system and method of the present disclosure may permit the creation of a time line and linking one or more unstructured data with a totally different set of unstructured data, and where an action can be triggered, relative to and in between each media artifact, can greatly enhance the user experience. A time line and time stamp may be leveraged to accomplish the linkage while maintaining the independent nature of each artifact. For example, a student while watching a video can be redirected to another media resource (like an e-book, video, etc.) and redirected back to the original video once the complete context has been provided. Creating a time line and linking one or more unstructured data with a totally different set of unstructured data, and where an action can be triggered, relative to and in between each media artifact, can greatly enhance the user experience.

The system and method of some embodiments further allow for interlinking and establishing relationships between multiple data artifacts so that a set of actions by one or more users can be recorded and then replayed.

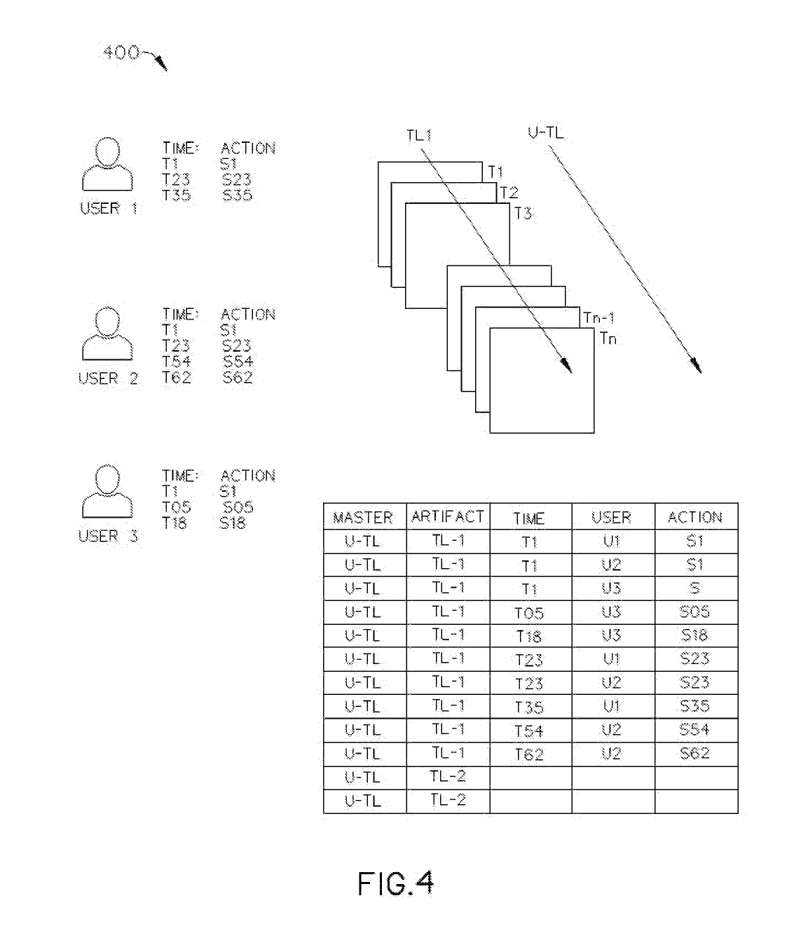

By way of example, FIG. 4 conceptually illustrates a schematic view 400 of a time stamp table used in relation to actions set by one or more users of a media content data annotating and linking system in some embodiments. As shown in this figure, a time line (TL1) or a set of time stamps associated with a master time line for each user (U-TL) are used which indicate when to perform an action or set of actions (e.g., opening a file to a particular page, starting a video from a specific point, etc.). A set of artifacts are related to specific points along the time line TL1, and some of the artifacts may have embedded or existing relative time lines, like in video and audio content. These elements can be started and stopped based on their points along the master time line or relative to each other, other annotations or data can also be added to these artifacts at specific points relative to the artifacts time line or master time line. Also, some of the artifacts may not have relative time lines that are embedded or existing. These could be files in specific formats, such as PDF, standalone images, website links, social media sites, etc. These files could be opened, scrolled and actions displayed according to the master time line or in relation to the specific artifact time lines. The action information for doing this is organized in a table or other satisfactory database format, which is stored and retrieved from the database of the system.

Also, the group management system will manage the list of users and their associated sharing relationships. As shown in FIG. 4, there are three users with associated actions to be performed in relation to various time locations. Specifically, User 1 has set action Si to occur at time t1 along time line TL1. Thus, the table includes an artifact entry for the action Si set by user U1 at time T1 under master time line U-TL. The table also includes entries for two other actions set by User 1, including action S23 at time t23 and action S35 at time t35. User 2 has set four actions, S1, S23, S54, and S62, which are included in the table and associated with times t1, t23, t54, and t62, respectively. Finally, User 3 has set three actions, S1, S05, and S18, to occur at time t1, t05, and t18, respectively. In this way, the media content data annotating and linking system offers the chance to work in collaborative environments in which multiple users provide artifacts and actions to form an artifact module that is a capsule of the users' experience.

The system and method of some embodiments may be used to link various artifacts/media like video, audio, files, text etc., so that a viewer is then able to see information from multiple sources in a predetermined manner. In addition, each of these artifacts could be annotated by multiple users and shared on a network. Thus, in the example shown in FIG. 4, additional artifact time lines (e.g., TL-2, etc.) could be used by users in setting various actions and operations related to other resources (e.g., a different file with a different set of actions and/or annotation artifacts, along a different relative time line TL-2).

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

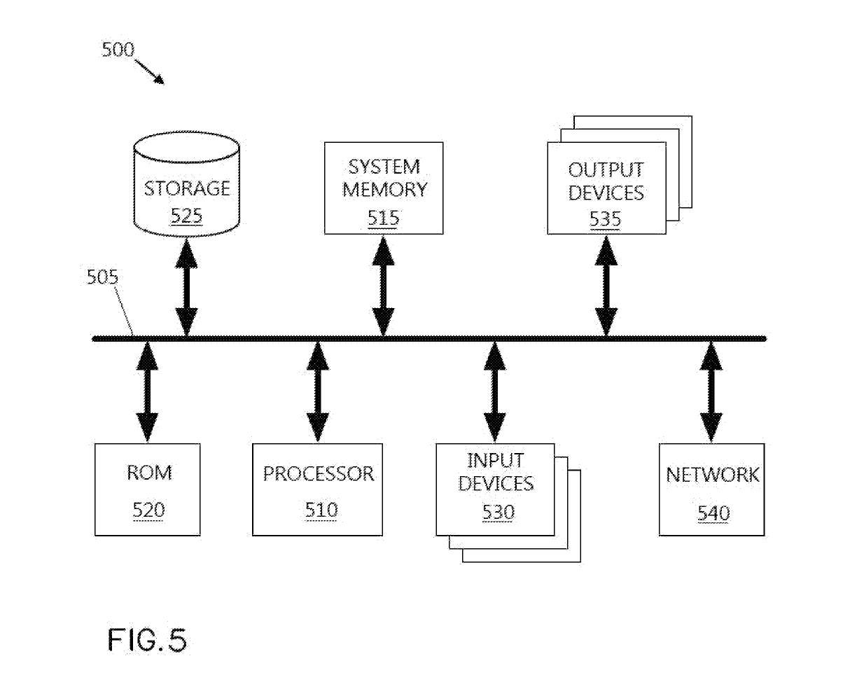

FIG. 5 conceptually illustrates an electronic system 500 with which some embodiments of the invention are implemented. The electronic system 500 may be a computing device, such as a desktop computer, a laptop computer, a tablet computing device, a portable hand-held computing device, a portable communications devices (such as a mobile phone), a personal digital assistant (PDA) computing device, or any other sort of electronic device. Such an electronic system includes various types of computer readable media and interfaces for various other types of computer readable media. Electronic system 500 includes a bus 505, processing unit(s) 510, a system memory 515, a read-only 520, a permanent storage device 525, input devices 530, output devices 535, and a network 540.

The bus 505 collectively represents all system, peripheral, and chipset buses that communicatively connect the numerous internal devices of the electronic system 500. For instance, the bus 505 communicatively connects the processing unit(s) 510 with the read-only 520, the system memory 515, and the permanent storage device 525.

From these various memory units, the processing unit(s) 510 retrieves instructions to execute and data to process in order to execute the processes of the invention. The processing unit(s) may be a single processor or a multi-core processor in different embodiments.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some embodiments of the invention use a mass-storage device (such as a magnetic or optical disk and its corresponding disk drive) as the permanent storage device 525.

Other embodiments use a removable storage device (such as a floppy disk or a flash drive) as the permanent storage device 525. Like the permanent storage device 525, the system memory 515 is a read-and-write memory device. However, unlike storage device 525, the system memory 515 is a volatile read-and-write memory, such as a random access memory. The system memory 515 stores some of the instructions and data that the processor needs at runtime. In some embodiments, the invention's processes are stored in the system memory 515, the permanent storage device 525, and/or the read-only 520. For example, the various memory units include instructions for processing appearance alterations of displayable characters in accordance with some embodiments. From these various memory units, the processing unit(s) 510 retrieves instructions to execute and data to process in order to execute the processes of some embodiments.

The bus 505 also connects to the input and output devices 530 and 535. The input devices enable the user to communicate information and select commands to the electronic system. The input devices 530 include alphanumeric keyboards and pointing devices (also called “cursor control devices”). The output devices 535 display images generated by the electronic system 500. The output devices 535 include printers and display devices, such as cathode ray tubes (CRT) or liquid crystal displays (LCD). Some embodiments include devices such as a touchscreen that functions as both input and output devices.

Finally, as shown in FIG. 5, bus 505 also couples electronic system 500 to a network 540 through a network adapter (not shown). In this manner, the computer can be a part of a network of computers (such as a local area network (“LAN”), a wide area network (“WAN”), or an Intranet), or a network of networks (such as the Internet). Any or all components of electronic system 500 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 2 conceptually illustrate a process. The specific operations of this process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details and examples, but rather is to be defined by the appended claims.

I claim:

1. A non-transitory computer readable medium storing a program which when executed by at least one processing unit of a computing device creates an artifact module with multiple linked media file artifacts, the program comprising sets of instructions for:
establishing a master time line;
receiving a selection of a file as a starting artifact for the artifact module;
creating an artifact module comprising a set of artifact linking designations that incorporate a set of artifacts to the starting artifact;
receiving selections for a set of actions to add to the artifact module at specific time points along one of the master time line and a native time line of a media content artifact; and
replaying the set of actions added to the media content module.

2. The non-transitory computer readable medium of claim 1, wherein the program further comprises a set of instructions for sharing the artifact module with a set of recipient users.

3. The non-transitory computer readable medium of claim 2, wherein the set of instructions for sharing the artifact module comprise a set of instructions for limiting the actions and accessibility of the incorporated artifacts in the artifact module for each recipient user based on a set of security permissions and group-level permissions set for the recipient.

4. The non-transitory computer readable medium of claim 2, wherein the set of instructions for sharing the artifact module comprises a set of instructions for setting a recipient-level sharing permission that allows a recipient user to share the artifact module with other users.

5. The non-transitory computer readable medium of claim 2, wherein the set of instructions for sharing the artifact module comprises a set of instructions for setting a recipient-level adding permission that allows a recipient user to add artifacts, actions, and annotations to the artifact module.

6. The non-transitory computer readable medium of claim 1, wherein the program further comprises a set of instructions for specifying at an action level that a particular action added to the artifact module can be shared with other recipient users playing the artifact module.

7. The non-transitory computer readable medium of claim 6, wherein the action level specification includes sharing the annotations and other artifacts associated with the artifact module.

8. A media content data annotating and linking system that provides media context and facilitates media replay, the system comprising:
a master time line for simulating time flow in relation to playback of one or more media content artifacts;
a first set of artifacts, each artifact in the first set comprising media content and a native time line;
a second set of artifacts, each artifact in the second set comprising media content without a native time line;
a database that stores a first set of time line locations associated with native time lines of one or more artifacts in the first set of artifacts, a second set of time line locations associated with the master time line, and a set of user identities associated with the first and second set of artifacts; and
a group management system that manages security and access permissions of a set of users.

9. The media content data annotating and linking system of claim 8, wherein the first set of artifacts comprise a set of video content files that each have a time line embedded in the video content for playback of the video.

10. The media content data annotating and linking system of claim 8, wherein the second set of artifacts comprise a set of unstructured data files without a time line, wherein each unstructured data file is accessible to a user at a relative time that is specified in the master time line.
